(19) United States
(12) Patent Application Publication
(10) Pub. No.: US 2025/0267478 A1
(43) Pub. Date: Aug. 21, 2025

(54) PROVISIONING CONTROL LOOP GOALS FOR WIRELESS NETWORKS

(71) Applicant: LENOVO (SINGAPORE) PTE LIMITED, Singapore (SG)

(72) Inventor: Ishan VAISHNAVI, Munich (DE)

(21) Appl. No.: 18/858,670

(22) PCT Filed: Apr. 21, 2023
(86) PCT No.: PCT/IB2023/054119

§ 371 Date: Oct. 21, 2024

Related U.S. Application Data
(60) Provisional application No. 63/334,046, filed on Apr. 22, 2022.

(51) Int. Cl. H04W 24/02; H04L 41/16; H04W 4/50

(52) U.S. Cl. CPC H04W 24/02; H04L 41/16; H04W 4/50

(57) ABSTRACT

A closed control loop in a management domain of a communication system may be automatically configured by receiving a service specification, translating the service specification to produce a control loop goal configurable in the management domain, and configuring the closed control loop according to the control loop goal.

### CROSS REFERENCE TO RELATED APPLICATIONS

This application claims priority to U.S. Provisional Patent Application No. 63/334,046, filed on Apr. 22, 2022, entitled PROVISIONING CONTROL LOOP GOALS FOR WIRELESS NETWORKS, which is hereby incorporated by reference in its entirety.

### TECHNICAL FIELD

The present disclosure relates to wireless communications, and more specifically to automatic determination of control loop goals for closed control loops in a wireless communication system.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system, including time resources (e.g., symbols, slots, subframes, frames, or the like), frequency resources (e.g., subcarriers, carriers), or combinations thereof. Additionally, the wireless communications system may support wireless communications across various radio access technologies including third generation (3G) radio access technology, fourth generation (4G) radio access technology, fifth generation (5G) radio access technology, among other suitable radio access technologies beyond 5G.

A wireless communication system may include one or more managed objects that are managed using one or more control loops. A control loop monitors information provided by one or more observation producers in the network, analyzes the information, determines one or more actions to be taken in response to the analysis, and then executes the actions by providing commands to one or more controlled entities in the network. The control loops attempt to control the managed object to keep it as close as possible to one or more goals, which goals are referred to herein as control loop goals.

A control loop can be an open control loop or a closed control loop. In an open control loop, an operator (for example, a person authorized to manage the network) participates in the control loop, such as by participating in the determinations of what if any actions should be taken in response to the analysis. A closed control loop is distinguished from an open control loop in that there is no operator involved in the closed control loop (other than for possibly configuring and adjusting the control loop goals for it).

The managed objects in a wireless communication system may change over time, with managed objects being added and removed. Accordingly, one or more control loop goals for any closed control loop associated with a newly-created managed object may need to be configured in accordance with requirements (such as performance goals) for the newly-created managed object. Traditionally, the determination of these control loop goals involved an operator having the necessary expertise and authority.

### SUMMARY

The present disclosure relates to methods, apparatuses, and systems that support automatic determination of control loop goals for closed control loops. By enabling the wireless communication system, including one or more network communication devices or user communication devices, or both, to automatically determine the control loop goals for the closed control loops without the participation of an operator, the speed of management operations of the wireless communication system may be improved, and the need for skilled personnel may be reduced, which increase the reliability and decreases the cost of performing the management operations.

The control loop goals may be determined according to a service specification. The service specification may include requirements regarding of a set of services provided by the wireless communication system. The requirements may include, for example, requirements related to availability, reliability, latency, data throughput, security, or combinations thereof.

Some implementations of the method and apparatuses described herein generate a control loop goal for a closed control loop in a first management domain of a wireless communication system by receiving a service specification, generating a first control loop goal associated with the first management domain based at least in part on the received service specification, and configuring the closed control loop according to the first control loop goal.

In some implementations of the method and apparatuses described herein, the method and apparatuses generate a second control loop goal associated with a second management domain based at least in part on the received service specification, and transmit the second control loop goal to the second domain.

In some implementations of the method and apparatuses described herein, the method and apparatuses determine a partial service specification for a second domain based at least in part on the service specification, and transmit the partial service specification to the second domain.

In some implementations of the method and apparatuses described herein, the method and apparatuses generate the first control loop goal based from the received service specification in combination with network operator specified preferences, constraints, or requirements.

In some implementations of the method and apparatuses described herein, the network operator specified preferences, constraints, or requirements are configured in a mapping table or a machine learning model, wherein one or both of the mapping table or the machine learning model correlates one or more parameters of the received service specification to the first control loop goal

In some implementations of the method and apparatuses described herein, the machine learning model is trained based on historical information of the communication network.

In some implementations of the method and apparatuses described herein, determining the first control loop goal comprises sending a request for supported assurance goals to a management entity of the first management domain, receiving information on the supported assurance goals, and determining the first control loop goal according to the information on the supported assurance goals.

In some implementations of the method and apparatuses described herein, the service specification includes a Network Slice Type (NEST) specification, a slice profile, a service profile, or a combination thereof.

### BRIEF DESCRIPTION OF THE DRAWINGS

FIG. 1 illustrates an example of a wireless communications system that supports automatic determination and configuration of control loop goals in accordance with aspects of the present disclosure.

FIG. 2 illustrates types of control loops that may be present in a communications system that supports automatic determination and configuration of control loop goals in accordance with aspects of the present disclosure.

FIG. 3 illustrates a model of a closed control loop for which control loop goals are automatically determined and configured in accordance with aspects of the present disclosure.

FIG. 4 illustrates an example of management domains of a wireless communications system that supports automatic determination and configuration of control loop goals in accordance with aspects of the present disclosure.

FIG. 5 illustrates an example of a process of identifying network requirements that supports automatic determination and configuration of control loop goals in accordance with aspects of the present disclosure.

FIG. 6 illustrates a process for automatic determination and configuration of control loop goals in accordance with aspects of the present disclosure.

FIG. 7 is a block diagram of a device that supports automatic determination and configuration of control loop goals in accordance with aspects of the present disclosure.

FIG. 8 illustrates a flowchart of a method that support automatic determination and configuration of control loop goals in accordance with aspects of the present disclosure.

### DETAILED DESCRIPTION

Automation of functions that currently rely on human operator intervention is key to supporting and managing complex networks with multiple network slices in telecommunication systems. Closed control loops are important elements of such telecommunications systems, but need to be supplied with control loop goals adapted to meet the specific requirements of each new network slice that is instantiated in the communication systems. Historically, such control loop goals were determined by a human being (typically referred to as an operator).

Automation of communication systems has focused on automatically provisioning resources to support core functions of a network slice or a service. However, the configuration of those automation elements with goals has been assumed to be manually performed.

This disclosure relates to provisioning the assurance enablers—that is, the portions of the system involved in assuring that operations goals are met, including the pertinent closed control loops—automatically. In particular, this disclosure relates to automatically deriving control loop goals for these closed control loops (referred to as AssuranceGoals in the pertinent 3GPP specifications) from provided service specifications. This enables a complete solution for automation wherein the service specification could be used to provision the service or slice including the automation enablers that support the slice. This reduces the capital expenditures (including personnel related expenses) for the operator, and may reduce the amount of time needed to go from receiving a service specification to having the specified service up and running on the communication system.

The closed control loops monitor a multitude of key performance indicators (KPIs) in pursuit of a multitude of goals in order to keep the communication system up and running according to the requirements and/or preferences of multiple stakeholders. The stakeholders may include end users, vertical consumer service providers, communication service providers, network operators, other domain operators, governing bodies, and vendors that supply the equipment and software needed to instantiate the communication system. Each of those stakeholders has their own set of objectives that need to be met by the operating communication system. Closed control loops running in the network are responsible for meeting these objectives; however, how the control loop goals for these closed control loops are derived from these diverse objectives has previously been unclear.

Aspects of the present disclosure are described in the context of a wireless communications system. Aspects of the present disclosure are further illustrated and described with reference to device diagrams, flowcharts, data flow diagrams, and data model diagrams that relate to the automatic determination and provisioning of control loop goals for closed control loops in a communication system.

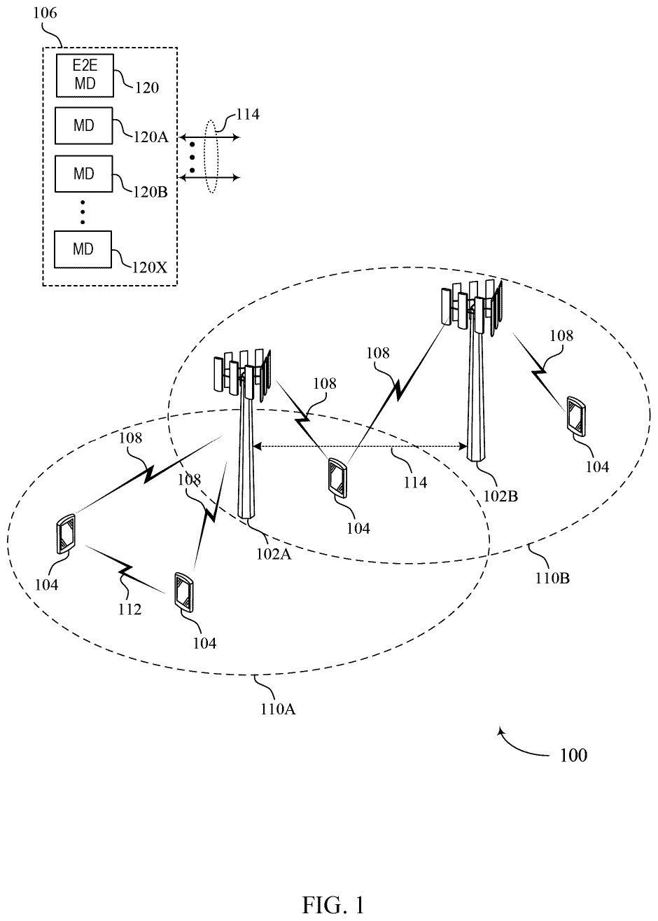

FIG. 1 illustrates an example of a wireless communications system 100 that supports automatic determination and configuration of control loop goals in accordance with aspects of the present disclosure. The wireless communications system 100 may include one or more base stations 102A and/or 102B, one or more UEs 104, and a core network 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as a 3^{rd} Generation Partnership Project (3GPP™) New Radio (NR) network. In other implementations, the wireless communications system 100 may be a combination of a 4G network and a 5G network. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more base stations (here, a first base station 102A and a second base station 102B, but embodiments are not limited thereto) may be dispersed throughout a geographic region to form the wireless communications system 100. One or more of the base stations 102A or 102B described herein may be or include or may be referred to as a network entity, a network communication device, a base transceiver station, an access point, a NodeB, an eNodeB (eNB), a next-generation NodeB (gNB), or other suitable terminology. A base station 102A or 102B and a UE 104 may communicate via a communication link 108, which may be a wireless or wired connection.

The first and second base stations 102A and 102B may respectively provide first and second geographic coverage areas 110A and 110B for which each base station may support services (e.g., voice, video, packet data, messaging, broadcast, etc.) for one or more UEs 104 within the geographic coverage area 110. For example, a base station 102A or 102B and a UE 104 may support wireless communication of signals related to services (e.g., voice, video, packet data, messaging, broadcast, etc.) according to one or multiple radio access technologies. In some implementations, one or more of the base stations 102A and 102B may be moveable, for example, a satellite associated with a non-terrestrial network. In some implementations, the geographic coverage areas 110A and 110B may be associated with the same or different radio access technologies and may overlap, but the different geographic coverage areas 110A and 110B may be respectively associated with different base stations 102A and 102B. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the base stations 102A and/or 102B, other UEs 104, or network equipment (e.g., the core network 106, a relay device, an integrated access and backhaul (IAB) node, or another network equipment), as shown in FIG. 1. Additionally, or alternatively, a UE 104 may support communication with other base stations 102A and/or 102B or UEs 104, which may act as relays in the wireless communications system 100.

A UE 104 may also be able to support wireless communication directly with other UEs 104 over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104 may support wireless communication directly with another UE 104 over a PC5 interface.

The first base station 102A may support communications with the core network 106, or with the second base station 102B, or both. For example, the base station 102A may interface with the core network 106 through one or more backhaul links 114 (e.g., via an S1, N2, N2, or another network interface). The base stations 102A and 102B may communication with each other over the backhaul links 114 (e.g., via an X2, Xn, or another network interface). In some implementations, the base stations 102A and 102B may communicate with each other directly (e.g., between the base stations 102A and 102B). In some other implementations, the base stations 102A and 102B may communicate with each other or indirectly (e.g., via the core network 106). In some implementations, one or more base stations 102A and/or 102B may include subcomponents, such as an access network entity, which may be an example of an access node controller (ANC). An ANC may communication with the one or more UEs 104 through one or more other access network transmission entities, which may be referred to as a radio heads, smart radio heads, or transmission-reception points (TRPs).

The core network 106 may comprise one or more computers and associated communication interconnects, and may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), one or more access and mobility management functions (AMFs), and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more base stations 102A and/or 102B associated with the core network 106.

The core network 106 may also comprise a plurality of management domains, such as an End-to-End (E2) management domain 120 and first through X^{th} management domains 120A . . . 120X.

Management domains are a collection of resources that have their own management system. A management system is, for example, any set of management services or their implementations in management functions.

A management domains may comprise management services that are restricted in scope, such as to one or more vendor's devices (which may have their own management system), one or more vendor's solutions, one or more technical domains (such as 3GPP core or 3GPP RAN), one or more cloud domains, one or more datacenters, one or more transport networks (which may have their own controllers), one or more operator administrative domains, one or more geographic domains, and so forth, or combinations thereof. For example, first and second management domains 120A and 120B may respectively comprise management services for first and second geographic coverage areas 110A and 110B, and an X^{th} management domain 120X may comprise management services for a particular vendors equipment at one or more of the base stations 102A and 102B; however, these illustrative examples are not limiting.

Each of the management domains in the wireless communications system 100 may include one or more closed control loops having one or more respective control loop goals, and the wireless communications system 100 may automatically determine and configure the control loop goals, The control loop goals may be automatically determined based on requirements of a user of the wireless communications system 100.

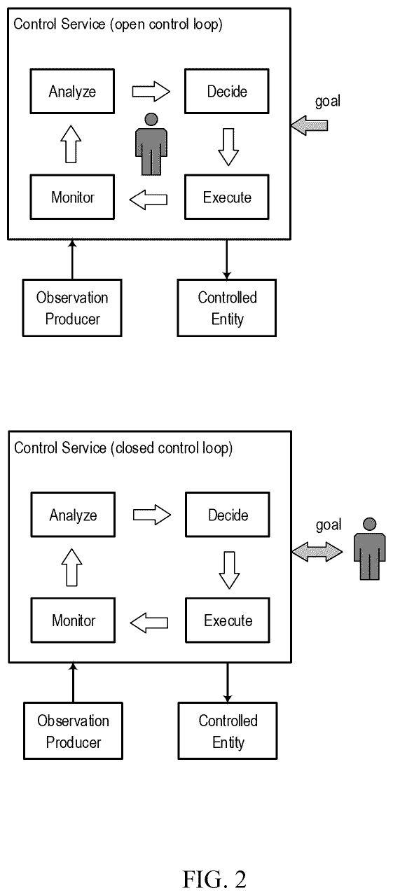

FIG. 2 illustrates types of control loops that may be present in a communications system that supports automatic determination and configuration of control loop goals in accordance with aspects of the present disclosure. In particular, FIG. 2 illustrates a control service using an open control loop (top) and a control service using an closed control loop (bottom).

Each of the illustrative open and closed control loops shown in FIG. 2 includes respective monitor, analyze, decide, and execute stages. Both control loops attempt to control the status of a managed object in order to keep it as close as possible to the control loop goals provided to each loop.

The difference between the open control loop and the closed control loop is the level of operator involvement in each control loop.

The open control loop involves the operator in at least one of the monitor, analyze, decide, and execute stages of the loop. The operator may also provide the goal for the open control loop.

In contrast, the closed control loop does not involve the operator in any of the monitor, analyze, decide, and execute stages of the loop. The operator only defines a control loop goal for the closed control loop. The closed control loop, once configured, runs automatically.

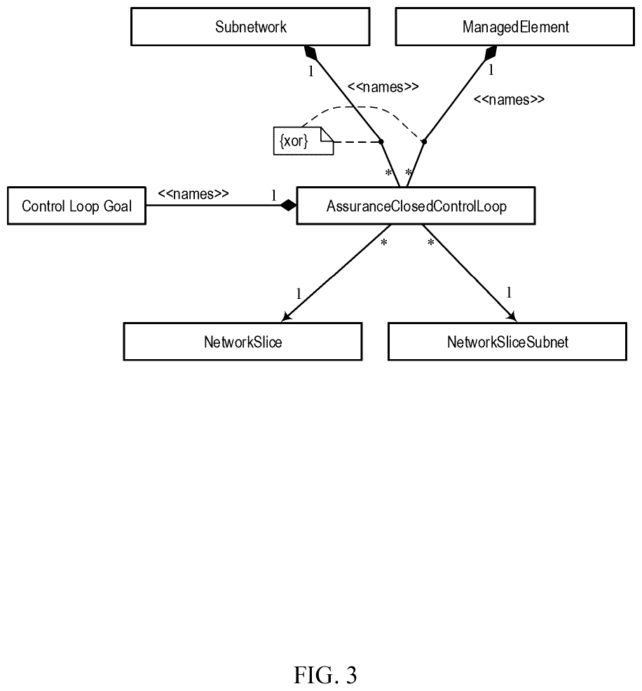

FIG. 3 illustrates a model of a closed control loop for which control loop goals are automatically determined and configured in accordance with aspects of the present disclosure. The model is promulgated in the 3^{rd} Generation Partnership Project (3GPP™) Technical Specification 28.536 (TS 28.536), which describes a closed control loop assurance solution that may be applied to, among other systems, 5th Generation (5G) wireless communication systems.

5G introduces the concept of network slicing. Network slicing enables an operator of a communication system to support different services for different vertical customers (such as Vehicle-to-Everything (V2X) communications, Internet of Things (IoT) communications, enhanced Mobile BroadBand (eMBB), Ultra-Reliable Low-Latency Communications (URLLC), and so on). The network slices may be hosted over virtualized infrastructure across one or more management domains. Closed control loops are key enabler for achieving automation of network slice provisioning and operation.

In TS 28.536 and the companion 3GPP Technical Specification 28.535 (TS 28.535), closed control loops are described using the information model shown FIG. 3. Accordingly, TS 28.536 models a closed control loop as an AssuranceClosedControlLoop object comprising zero or more SubNetwork objects or zero or more ManagedElement objects, each having a respective name. The model AssuranceClosedControlLoop object further comprises zero or more NetworkSlice objects having respective names, and zero or more NetworkSliceSubnet object having respective names.

The model AssuranceClosedControlLoop object may receive zero or more AssuranceGoal objects, each having a respective name and each representing a respective control loop goal and having corresponding observed or predicted goal fulfilment information.

One or more AssuranceClosedControlLoop objects may be applied to the management of each network slice or network slice subnet; in some cases, a large number of AssuranceClosedControlLoop objects may be applied.

The control loop goal(s) corresponding to a closed control loop can be set by any authorized consumer of the closed control loop and consists of an assurance TargetList which, in TS 28.536, is a list of name-value pairs, each pair indicating a Key Performance Indicator (KPI) goal that the closed loop should try to achieve, that is, a control loop goal. In general, these control loop goal may be an optimization related criterion (max/max), an inequality (less than or greater than), an equality constraint (name=value), and so on. Different network slice instances or different network slice subnet instances may have different goals for the respective closed control loops responsible for a particular controlled entity within each network slice instance or network slice subnet instance.

However, TS 28.536 does not address how the control loop goals for the closed control loops are determined. The control loop goals may be determined by the administrators of the communication system, however this requires the administrators (operators) to have expertise in the communication system and in how the automation of network functions in the communication system is performed.

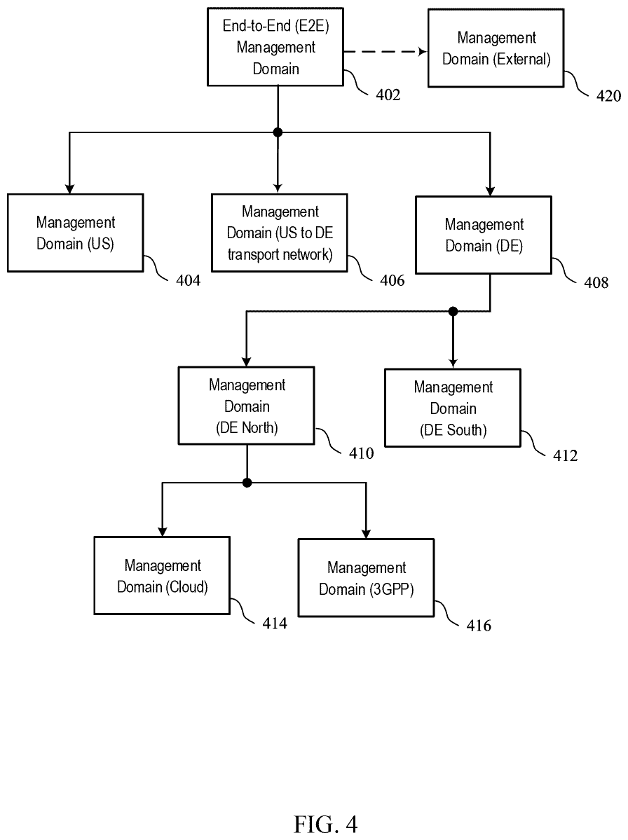

FIG. 4 illustrates an example of management domains of a wireless communications system that supports automatic determination and configuration of control loop goals in accordance with aspects of the present disclosure.

FIG. 4 shows an example of a possible deployment of management domains for an operator that provides service in two geographic domains; in the example, the United States (US) and Germany (DE). Only the German domain is further expanded to show recursion in management domains. Further domains such as vendor specific management domains/equipment (not shown) may be included in the management domains.

In FIG. 4, an End-to-End (E2E) management domain 402 encompasses management of operation of the service that span the entirety of the communication system. Within the E2E management domain 402, a first management domain 404 encompasses management of operation of the service within the US, a second management domain 406 encompasses management of a communication network that connects the US portions of the communication system to the German portions, and a third management domain 408 encompasses management of operations of the service within Germany.

Within the third management domain 408, a fourth management domain 410 encompasses management of operation of the service in a northern region of Germany, and a fifth management domain 412 encompasses management of operation of the service in a southern region of Germany.

Within the fifth management domain 412, a sixth management domain 414 encompasses management of cloud services in the northern region of Germany, and a seventh management domain 416 encompasses management of 3GPP operations in the northern region of Germany.

The E2E management domain 402 may further communicate with an external management domain 420.

In an embodiment, one or more of the management domains shown in FIG. 4 may receive one or more requirements from one or more consumers and/or operators, from each of one or more of the other management domains, or both; automatically determine a control loop goal according to the received requirements; and may configure a closed control loop according to the determined control loop goal.

In an embodiment, one or more of the management domains shown in FIG. 4 may receive one or more requirements from one or more consumers and/or operators, from each of one or more of the other management domains, or both; may derive a requirement for another management domain according to the received requirements; and may transmit the derived requirement to the other management domain.

In an embodiment, one or more of the management domains shown in FIG. 4 may receive one or more requirements from one or more consumers and/or operators, from each of one or more of the other management domains, or both; may translate the received requirements into a control loop goal for a closed control loop of another management domain according to the received requirements; and may transmit the translated control loop goal to the other management domain.

In an embodiment, one or more of the management domains shown in FIG. 4 may receive a control loop goal from one of the other management domains and may configure a closed control loop in accordance with the received control loop goal.

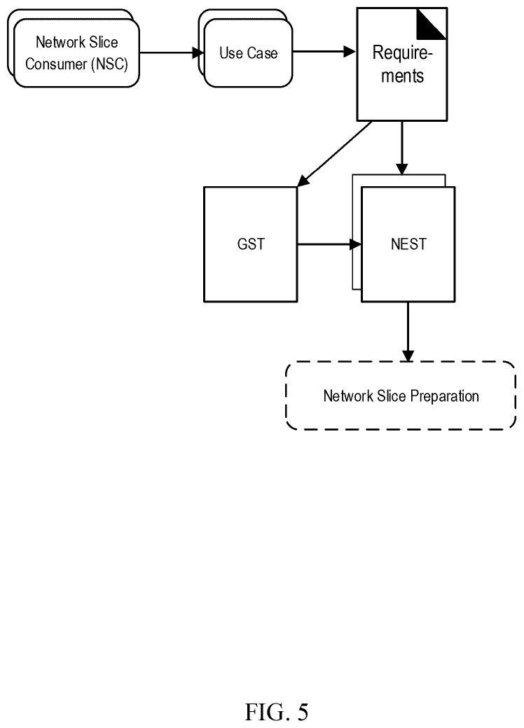

FIG. 5 illustrates an example of a process of identifying network requirements that supports automatic determination and configuration of control loop goals in accordance with aspects of the present disclosure.

FIG. 5 shows one or more Network Slice Consumers (NSC), that is, recipients of services to be provided by a network slice, generating requirements according to one or more use cases. The requirements are used to generate one or more NEtwork Slice Type (NEST) objects according to a Groupe Speciale Mobile Association (GSMA) Generic network Slice Template (GST) such as specified in GSMA Permanent Reference Document (PRD) NG.116. Each NEST identifies network requirements for a slice instance. This NEST may be used in network slice preparation by management system of both 3GPP communication systems and non-3GPP communication systems.

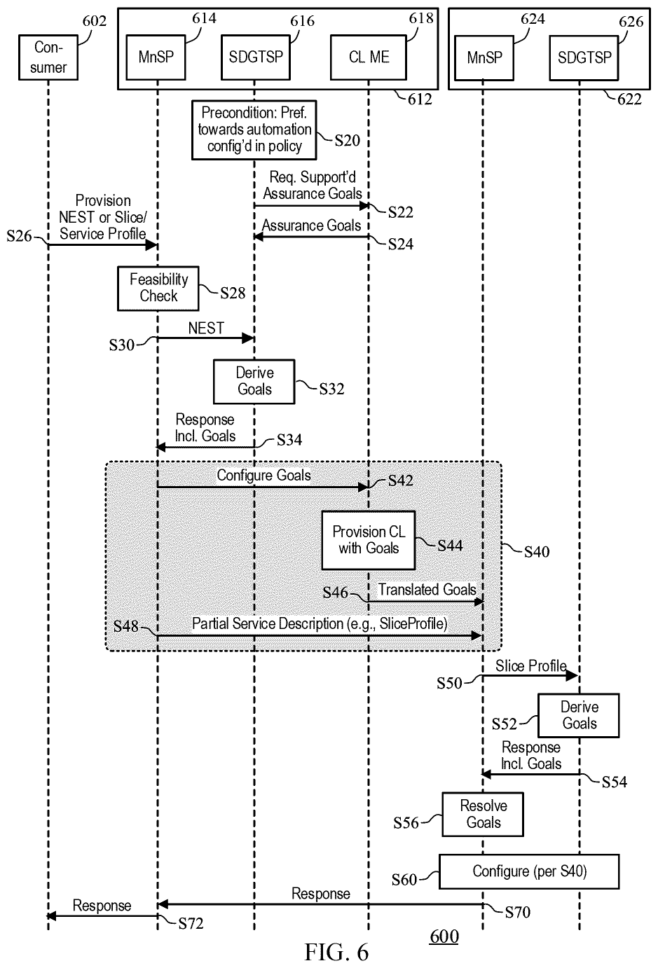

FIG. 6 illustrates a process 600 for automatic determination and configuration of control loop goals for closed control loops in accordance with aspects of the present disclosure. The process 600 may be performed by a network service provided, for example, by a processor executing computer-readable instructions from non-transitory computer-readable media, which network service provides automation goals that a network management system for a communication system.

The illustrative example of the process 600 illustrated in FIG. 6 involves a consumer 602 of services of the communication system, a first management domain 612, and a second management domain 622, but embodiments are not limited thereto.

The first management domain 612 includes a first management service provider (MnSP) 614, a control loop management entity (CL ME) 618, and a first Service Description to Goal Translation Service Producer (SDGTSP) 618. The second management domain 622 includes a second MnSP 624 and a second SDGTSP 626. The first and second management domains 612 and 622 may further include other entities that are not shown; for example, like the first management domains 612, the second management domains 612 may include a control loop management engine.

The process 600 may be realized based on the SMA GST parameters received as a NEST request, or the intent specification, serviceProfile or sliceProfile. The operator may configure policies that influence translation of NEST parameters into control loop goals.

An example of such translation that can be done using a GST attribute is Mission-critical support. When this value is set it implies that the slice has the highest priority in the network and must not fail. This would be typical for network slices that may support emergency services. This implies that the reliability level for this network slice should be 100% when possible. Hence an control loop goal for this network slice instance would be to maximize reliability beyond 99.999%. Another control loop goal for this network slice instance that may be derived from the GST Mission-critical support attribute being set may be that energy efficiency is done at best effort.

An example on the other end of the spectrum would be when the guaranteed uplink parameter in the GST is set to 0, signifying best effort traffic for the network slice. In this case the operator preferences on what quality to provide against how much energy to save would need to be traded off. Therefore, the quality- and energy-related control loop goals would be derived from the previously-configured operator preferences as to the type of service the operator wishes to provide in this case, and not from the GST specification.

In embodiments, at S20, as a precondition, an operator has configured policies that reflect operator requirements for automation in the first SDGTSP 616.

In embodiments, at S22, the first SDGTSP 616 may request the operator requirements from the CL ME 618, and at S24 the requested requirements are provided to the first SDGTSP 616 by the CL ME 618. The requirements provided at S24 may be assurance goals selected to ensure that the requirements of a communication service service level specification are fulfilled.

At S26, the consumer 602 sends a request for provisioning to the first MnSP 614. The request includes a service description or network service descriptor for the service being requested. The service may include a communication service (such as may be specified in an end-to-end service description), a Network Slice Instance (such as may be described in a NEST or Service Profile), a Network Slice Subnet Instance (such as may be described in a Slice Profile), a network function (such as may be described in a network function descriptor), or combinations thereof.

At S28, the first MnSP 614 performs a feasibility check to determine whether the service described in the request received at S26 can be deployed. The feasibility check may be performed according to feasibility check procedure such as defined in 3GPP Technical Specification 28.531 (release 17).

At S30, when the feasibility check determines that the service specified in the request received at S26 can be deployed, the first MnSP 614 forwards the service description to the first SDGTSP 616.

At S32, the first SDGTSP 616 derives one or more loop control goals based on operator configuration and the information in the service description. This may be performed using a mapping table, configured by the operator, that maps GST parameters to the loop control goals, using an analytics model (for example a reinforcement learning model) trained based on the historical performance of past service description to control loop goal translations, or a combination thereof. For example, the mapping table may be used initially, and then the analytics model may be used once it has been trained enough to produce results as good or better than the mapping table.

At S34, the first SDGTSP 616 provides a list of the derived control loop goals that are to be configured in the network to the first MnSP 614.

At S40, the first MnSP 614 directs other entities to configure one or more closed control loops according to respective control loop goals produced by the first SDGTSP 616.

For example, within S40, at S42 the first MnSP 614 may direct the CL ME 618 to configure one or more closed control loops according to respective control loop goals produced by the first SDGTSP 616.

In response, at S44 the CL ME 618 provisions one or more closed control loops in the first management domain 612 with their respective control loop goals. Furthermore, the CL ME 618 may translate one or more of the received control loop goals into control loop goals for the second management domain 622 and at S46 may transmit the translated control loop goals to the second MnSP 624 of the second management domain 622.

Furthermore, within S40, at S48, first MnSP 614 may transmit those parts of the service description received at S26 that relate to the second management domain 622 to the second MnSP 624.

Steps S50, S52, S54, and S60 performed in the second management domain S622 respectively correspond to steps S30, S32, S34, and S40 performed in the first management domain S612, illustrating the recursive nature of domain management. Descriptions of S50, S52, S54, and S60 are therefore omitted in the interest of brevity.

At S56, the second MnSP 624 resolves any potential conflicts between the control loop goals received from the CL ME 618, the partial service description received from the first MnSP 614, and control loop goals derived from any service specification(s) input to the second management domain 622. If a resolutions to any conflict cannot be determined, then the configuration of the second management domain 622 fails.

At S70, the second MnSP 624 send an indication of whether the configuration of the second management domain 622 has succeeded back to the first MnSP 614.

At S72, the first MnSP 614 sends a response to the consumer indicating whether the provisioning requested at S26 has succeeded.

An embodiment of the present disclosure may be incorporated into an network slice instance allocation procedure such as described in 3GPP TS 28.531. The embodiment adds or modifies two steps in the network slice instance allocation procedure described in 3GPP TS 28.531.

First, the control loop goals for the closed control loops used in performance assurance at the network slice instance level are automatically derived from a service profile and operator internal preferences. The service profile may be derived from a NEST specification.

Then, the derived control loop goals, along with other requirements determined by the pertinent Network Slice Management Service Provider, are used to create the network slice subnet instance that is associated with the network slice instance.

Another embodiment of the present disclosure may be incorporated into a network slice subnet instance allocation procedure such as described in 3GPP TS 28.531. The embodiment adds or modifies six steps in the network slice subnet instance allocation procedure described in 3GPP TS 28.531.

The step of receiving an AllocateNSSI request may include receiving control loop goals related to the network slice subnet instance being allocated, where the control loop goals were generated by another embodiment of this disclosure.

A new step automatically derives control loop goals for closed control loops related to operation assurance from the SliceProfile provided with the allocateNSSI request. Overlaps and conflict resolution between the derived control loop goals and other goals for the network slice subnet instance may then be performed.

In step 4.1b.2 of the procedure described in 3GPP TS 28.531, the derived control loop goals are included with other goals sent to the network function virtualization management and network orchestration provider.

In step 4.1b.3a of the procedure described in 3GPP TS 28.531, the derived control loop goals are included with other goals sent to the respective Network Slice Subnet management Service Producer (NSSMS_P).

In step 4.1b.3b of the procedure described in 3GPP TS 28.531, the derived control loop goals are included with other goals sent to the NF Creation Procedure.

In step 4.1b.5 of the procedure described in 3GPP TS 28.531, the derived control loop goals are included with other goals sent to the invoked procedure of coordination with the relevant transport network manager

Another embodiment of the present disclosure may be incorporated into a network function instance creation procedure such as described in 3GPP TS 28.531. The embodiment adds or modifies three steps in the network function instance creation procedure described in 3GPP TS 28.531.

A new step automatically derives control loop goals for closed control loops related to operation assurance from the network function requirements.

In step 3 of the procedure described in 3GPP TS 28.531, the derived control loop goals are included with other goals sent to the virtual network function package management procedure.

In step 4 of the procedure described in 3GPP TS 28.531, the derived control loop goals are included in the requirements used when invoking the virtual network function lifecycle management.

Additionally, overlap and conflict resolution with the derived control loop goals and other requirements is performed.

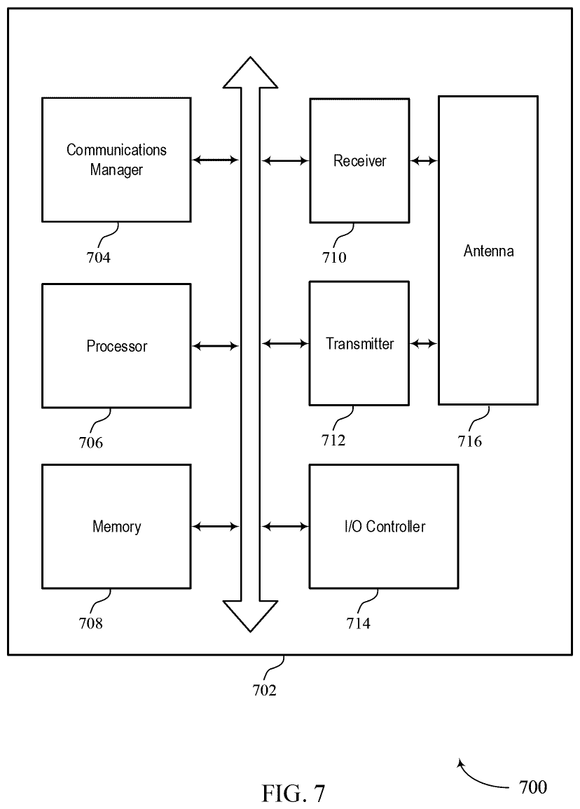

FIG. 7 illustrates a block diagram 700 of a device 702 that supports automatic determination and configuration of control loop goals in accordance with aspects of the present disclosure, wherein the process relies only on resources other than the untrusted network function. The device 702 may be an example of a base station 102, or of a computing system that supports one or more management domains in a core network 106, as described herein. The device 702 may support wireless communication with one or more base stations 102, UEs 104, other devices that implement respective network functions, or any combination thereof. The device 702 may include components for bi-directional communications including components for transmitting and receiving communications, such as a communications manager 704, a processor 706, a memory 708, a receiver 710, transmitter 712, and an I/O controller 714. These components may be in electronic communication or otherwise coupled (e.g., operatively, communicatively, functionally, electronically, electrically) via one or more interfaces (e.g., buses).

The communications manager 704, the receiver 710, the transmitter 712, or various combinations thereof or various components thereof may be examples of means for performing various aspects of the present disclosure as described herein. For example, the communications manager 704, the receiver 710, the transmitter 712, or various combinations or components thereof may support a method for performing one or more of the functions described herein.

In some implementations, the communications manager 704, the receiver 710, the transmitter 712, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 706 and the memory 708 coupled with the processor 706 may be configured to perform one or more of the functions described herein (e.g., by executing, by the processor 706, instructions stored in the memory 708).

Additionally or alternatively, in some implementations, the communications manager 704, the receiver 710, the transmitter 712, or various combinations or components thereof may be implemented in code (e.g., as communications management software or firmware) executed by the processor 706. If implemented in code executed by the processor 706, the functions of the communications manager 704, the receiver 710, the transmitter 712, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 704 may be configured to perform various operations (e.g., receiving, monitoring, transmitting) using or otherwise in cooperation with the receiver 710, the transmitter 712, or both. For example, the communications manager 704 may receive information from the receiver 710, send information to the transmitter 712, or be integrated in combination with the receiver 710, the transmitter 712, or both to receive information, transmit information, or perform various other operations as described herein. Although the communications manager 704 is illustrated as a separate component, in some implementations, one or more functions described with reference to the communications manager 704 may be supported by or performed by the processor 706, the memory 708, or any combination thereof. For example, the memory 708 may store code, which may include instructions executable by the processor 706 to cause the device 702 to perform various aspects of the present disclosure as described herein, or the processor 706 and the memory 708 may be otherwise configured to perform or support such operations.

For example, the communications manager 704 may support wireless communication at a first device (e.g., the device 702) in accordance with examples as disclosed herein. The communications manager 704 may be configured as or otherwise support a means automatically determining and configuring respective control loop goals for closed control loops employed to assure the performance of a communication system.

The processor 706 may include an intelligent hardware device (e.g., a general-purpose processor, a Digital Signal Processor (DSP), a Central Processor Unit (CPU), a microcontroller, an Application-Specific Integrated Circuit (ASIC), a Field-Programmable Gate Array (FPGA), a programmable logic device, a discrete gate or transistor logic component, a discrete hardware component, or any combination thereof). In some implementations, the processor 706 may be configured to operate a memory array using a memory controller. In some other implementations, a memory controller may be integrated into the processor 706. The processor 706 may be configured to execute computer-readable instructions stored in a memory (e.g., the memory 708) to cause the device 702 to perform various functions of the present disclosure.

The memory 708 may include random access memory (RAM) and read-only memory (ROM). The memory 708 may store computer-readable, computer-executable code including instructions that, when executed by the processor 706 cause the device 702 to perform various functions described herein. The code may be stored in a non-transitory computer-readable medium such as system memory or another type of memory. In some implementations, the code may not be directly executable by the processor 706 but may cause a computer (e.g., when compiled and executed) to perform functions described herein. In some implementations, the memory 708 may include, among other things, a basic I/O system (BIOS) which may control basic hardware or software operation such as the interaction with peripheral components or devices.

The I/O controller 714 may manage input and output signals for the device 702. The I/O controller 714 may also manage peripherals not integrated into the device 702. In some implementations, the I/O controller 714 may represent a physical connection or port to an external peripheral. In some implementations, the I/O controller 714 may utilize an operating system such as iOS®, ANDROID®, MS-DOS®, MS-WINDOWS®, OS/2®, UNIX®, LINUX®, or another known operating system. In some implementations, the I/O controller 714 may be implemented as part of a processor, such as the processor 706. In some implementations, a user may interact with the device 702 via the I/O controller 714 or via hardware components controlled by the I/O controller 714.

In some implementations, the device 702 may include a single antenna 716. However, in some other implementations, the device 702 may have more than one antenna 716, which may be capable of concurrently transmitting or receiving multiple wireless transmissions. The receiver 710 and the transmitter 712 may communicate bi-directionally, via the one or more antennas 716, wired, or wireless links as described herein. For example, the receiver 710 and the transmitter 712 may represent a wireless transceiver and may communicate bi-directionally with another wireless transceiver. The transceiver may also include a modem to modulate the packets, to provide the modulated packets to one or more antennas 716 for transmission, and to demodulate packets received from the one or more antennas 716.

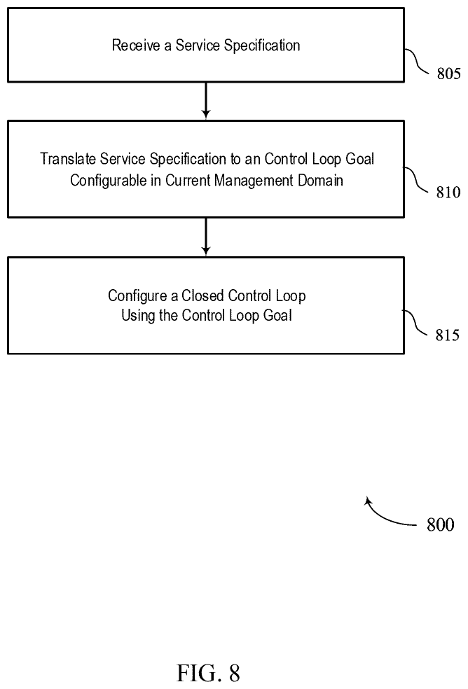

FIG. 8 illustrates a flowchart of a method 800 that support automatic determination and configuration of control loop goals in accordance with aspects of the present disclosure. The method may be performed by a device or its components as described herein. For example, the operations of the method may be performed by components of a management domain, as described with reference to FIGS. 1 through 7. In some implementations, the device may execute a set of instructions to control the function elements of the device to perform the described functions. Additionally, or alternatively, the device may perform aspects of the described functions using special-purpose hardware.

At 805, the device receives a service specification. The service specification may include, for example, a Network Slice Type (NEST) specification, a slice profile, a service profile, or a combination thereof.

At 810, the device generates a control loop goal associated with the management domain based at least in part on the service specification. Generating the control loop goal may be performed using a mapping table, a machine learning model, or a combination thereof, and may be based on information on supported assurance goals provided by a management entity.

At 815, the device configures the closed control loop according to the control loop goal. Configuring the closed control loop according to the control loop goal may be performed by providing the control loop goal to a control loop management entity or to another device.

The operations 805 through 815 of the device may be performed in accordance with examples as described herein. In some implementations, aspects of the operations may be performed by a device as described with reference to FIG. 7.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A network entity for wireless communication, comprising:
at least one memory; and
at least one processor coupled with the at least one memory and configured to cause the network entity to:
receive a service specification;
generate a first control loop goal associated with a first management domain based at least in part on the received service specification; and
configure a closed control loop in accordance with the first control loop goal.

2. The network entity of claim 1, wherein the at least one processor is further configured to cause the network entity to:
generate a second control loop goal associated with a second management domain based at least in part on the received service specification; and
transmit the second control loop goal to the second management domain.

3. The network entity of claim 1, wherein the at least one processor is further configured to cause the network entity to:
determine a partial service specification for a second management domain based at least in part on the received service specification; and
transmit the partial service specification to the second management domain.

4. The network entity of claim 1, wherein the at least one processor is configured to cause the network entity to generate the first control loop goal from the received service specification in combination with network operator specified preferences, constraints, or requirements.

5. The network entity of claim 4, wherein the network operator specified preferences, constraints, or requirements are configured in a mapping table or a machine learning model, wherein one or both of the mapping table or the machine learning model correlates one or more parameters of the received service specification to the first control loop goal.

6. The network entity of claim 5, wherein the machine learning model is trained based on historical information of a network associated with one or both of the first management domain or the second management domain.

7. The network entity of claim 1, wherein the at least one processor is further configured to cause the network entity to:
send a request for one or more assurance goals to a management entity of the first management domain;
receive information associated with the one or more assurance goals; and
determine the first control loop goal based at least in part on the received information associated with the one or more assurance goals.

8. The network entity of claim 1, wherein the received service specification comprises a network slice type (NEST) specification, a network slice profile, a service type, a service profile, or a combination thereof.

9. A method performed by a network service, the method comprising:
receiving a service specification;
generating a first control loop goal associated with a first management domain based at least in part on the received service specification; and
configuring a closed control loop in accordance with the first control loop goal.

10. The method of claim 9, further comprising:
generating a second control loop goal associated with a second management domain based at least in part on the received service specification; and
transmitting the second control loop goal to the second management domain.

11. The method of claim 9, further comprising:
determining a partial service specification for a second management domain based at least in part on the received service specification; and
transmitting the partial service specification to the second management domain.

12. The method of claim 9, further comprising:
generating the first control loop goal based at least in part on a translation of the received service specification using one or both of a mapping table or a machine learning model, wherein one or both of the mapping table or the machine learning model correlates one or more parameters of the received service specification to the first control loop goal.

13. The method of claim 12, wherein the machine learning model is trained based on historical information of a network associated with one or both of the first management domain or the second management domain.

14. The method of claim 12, further comprising:
obtaining one or both of the mapping table or, the machine learning model from an operator.

15. The method of claim 9, further comprising:
sending a request for one or more assurance goals to a management entity of the first management domain;
receiving information associated with the one or more assurance goals; and
determining the first control loop goal based at least in part on the received information associated with the one or more assurance goals.

16. The method of claim 9, wherein the received service specification comprises a network slice type, a network slice profile, a service type, a service profile, or a combination thereof.

17. A processor for wireless communication, comprising:
at least one controller coupled with at least one memory and configured to cause the processor to:
receive a service specification;
generate a first control loop goal associated with a first management domain based at least in part on the received service specification; and
configure a closed control loop in accordance with the first control loop goal.

18. The processor of claim 17, wherein the at least one controller is further configured to cause the processor to:
generate a second control loop goal associated with a second management domain based at least in part on the received service specification; and
transmit the second control loop goal to the second management domain.

19. The processor of claim 17, wherein the at least one controller is further configured to cause the processor to:
determine a partial service specification for a second management domain based at least in part on the received service specification; and
transmit the partial service specification to the second management domain.

20. The processor of claim 17, wherein the at least one controller is configured to cause the processor to generate the first control loop goal from the received service specification in combination with network operator specified preferences, constraints, or requirements.
